(19) United States
(12) Patent Application Publication
(10) Pub. No.: US 2010/0097180 A1
(43) Pub. Date: Apr. 22, 2010

(54) SYSTEM AND METHOD FOR CREDIT CARD USER IDENTIFICATION VERIFICATION

(76) Inventor: Mario W. Cardullo, Alexandria, VA (US)

Correspondence Address: MCGUIREWOODS, LLP, 1750 TYSONS BLVD, SUITE 1800, MCLEAN, VA, 22102, US

(21) Appl. No.: 12/582,477

(22) Filed: Oct. 20, 2009

Related U.S. Application Data
(60) Provisional application No. 61/107,207, filed on Oct. 21, 2008.

(51) Int. Cl. G05B 19/00

(52) U.S. Cl. 340/5.83; 382/124

(57) ABSTRACT

A system for verifying a credit card user's identification includes a scanner, a comparator and a control unit. The scanner is configured to scan a holographic fingerprint image on a credit card and a credit card user's fingerprint and output first fingerprint image data representing the holographic fingerprint image and second fingerprint image data representing the credit card user's fingerprint. The comparator configured to compare the first fingerprint image data and the second fingerprint image data and determine whether the first fingerprint image data matches the second fingerprint image data. A control unit configured to issue a verification message based on the first fingerprint image data and the second fingerprint image data.

### CROSS REFERENCE TO PRIOR APPLICATION

This application claims priority and the benefit thereof from U.S. Provisional Patent Application No. 61/107,207 filed on Oct. 21, 2008, which is hereby incorporated by reference for all purposes as if fully set forth herein.

### BACKGROUND OF THE INVENTION

1. Field of the Invention

This invention is directed to credit card user identification verification, and particularly to verifying a credit card user's identification based on a comparison of a credit card user's fingerprint to a credit card holder's holographic fingerprint image.

2. Related Art

Various attempts have been made to prevent credit card fraud. One approach is fingerprint based user identification verification, which requires the credit card users' fingerprint data be stored in a centralized data storage. When the credit card is used for a purchase, the credit card user's fingerprint is scanned and sent to the centralized data storage for comparison. When the scanned fingerprint matches the fingerprint stored in the data storage, payment may be authorized. This approach has significant disadvantages such as hacking, connectivity limitation, complexity, high costs, time delay, and the like. A number of other similar approaches to prevent credit card fraud exist that also have a number of disadvantages. Accordingly, there is a need for simpler and lower-cost credit card user identification verification.

### SUMMARY OF THE INVENTION

In one aspect of the invention, a system for verifying a credit card user's identification includes a scanner configured to scan a holographic fingerprint image on a credit card and a credit card user's fingerprint and output first fingerprint image data representing the holographic fingerprint image and second fingerprint image data representing the credit card user's fingerprint, a comparator configured to compare the first fingerprint image data and the second fingerprint image data and determine whether the first fingerprint image data matches the second fingerprint image data, and a control unit configured to issue a verification message based on the first fingerprint image data and the second fingerprint image data.

The control unit may be further configured to issue a verification success message when the first fingerprint image data matches the second fingerprint image data. The system may further include an output device configured to output one of the verification failure message when the first fingerprint image data does not match the second fingerprint image data. The output device may include at least one of a display unit, a speaker system and a printer.

The system may further include a communication unit configured to establish communication between the system and an electronic payment network. The control unit may be further configured to transmit the verification failure message to the electronic payment network when the first fingerprint image data does not match the second fingerprint image data.

The control unit may be further configured to transmit at least one of credit card data and the second fingerprint image data to the electronic payment network when the first fingerprint image data does not match the second fingerprint image data. The credit card data may include at least one of a credit card number, a credit card expiration date, a verification code and a credit card holder's name. The system may further include a card reader configured to retrieve the credit card data from the credit card.

In another aspect of the invention, a method of verifying a credit card user's identification includes scanning a holographic fingerprint image on a credit card to obtain first fingerprint image data, scanning a fingerprint of a user of the credit card to obtain second fingerprint image data, comparing the first fingerprint image data and the second fingerprint image data to determine whether or not the first fingerprint image data matches the second fingerprint image data, and outputting a verification message based on the first fingerprint image data and the second fingerprint image data.

The method may further include outputting a verification success message when the first fingerprint image data matches the second fingerprint image data. Also, the method may further include sending the verification failure message to an electronic payment network when the first fingerprint image data does not the second fingerprint image data. Further, the method may further include sending at least one of credit card data and the second fingerprint image data to the electronic payment network when the first fingerprint image data does not match the second fingerprint image data. The method may further include retrieving the credit card data from the credit card.

The outputting a verification failure message may include at least one of displaying the verification failure message, playing a sound and printing out verification failure message. The credit card data may include at least one of a credit card number, a credit card expiration date, a verification code and a credit card holder's name.

In another aspect of the invention, a method of making a credit card includes obtaining a three dimensional impression of a customer's fingerprint, scanning the three dimensional impression to obtain a three dimensional fingerprint image data, creating a holographic fingerprint image from the three dimensional fingerprint image data, printing the holographic fingerprint image, and embedding the printed holographic fingerprint image to a credit card.

The obtaining the three dimensional fingerprint impression may include pressing the customer's fingertip to an impression pad to leave the three dimensional fingerprint impression thereon. The method may further include storing credit card data to the credit card, wherein the credit card data comprises at least one of a credit card number, a credit card expiration date, a verification code and a customer's name.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a credit card with a three dimensional holographic fingerprint image constructed according to the principles of the invention;

FIG. 2 shows a credit card user identity verification system constructed according to the principles of the invention;

FIG. 3 shows a flowchart of a credit card user identification verification process implemented according to the principles of the invention; and

FIG. 4 shows a flowchart of a credit card manufacturing process implemented according to the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

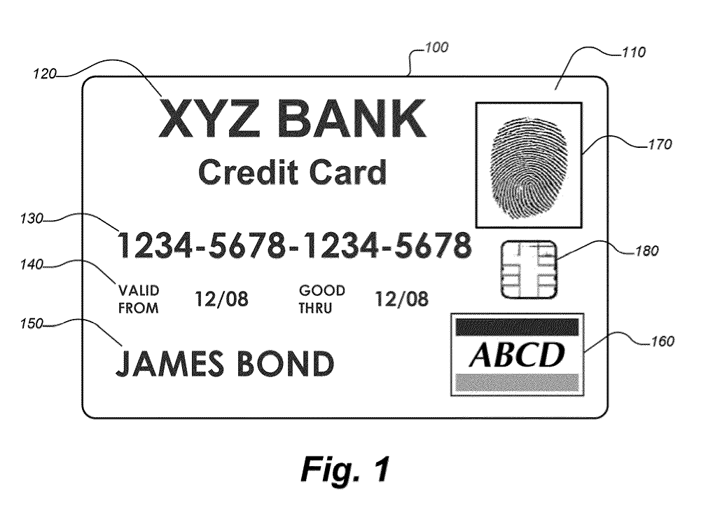

FIG. 1 shows a credit card 100 with a credit card user identification verification feature constructed according to the principles of the invention. The credit card 100 may be indifferent from any other credit cards in terms of the configuration (e.g., a size, thickness, weight, material and the like). However, other configurations or arrangements are contemplated. Furthermore, just like any other credit cards currently being used, the card 100 may show, on a front side 110 thereof, a credit card issuing bank or financial institution's name 120, a credit card number 130, “valid from” and/or “good thru” dates 140, a name 150 of the person to whom the credit card 100 is issued (hereafter “a credit card holder), an electronic payment network logo 160 (e.g., a VISA™ logo, a MasterCard™ logo, an American Express™ logo, a Discover™ logo or the like) and/or the like. The card 100 may further include a data storage, such as, e.g., a data chip 180 (e.g., a smart chip) typically located on the front side 110 of the credit card 100, a magnetic stripe (not shown) typically located on a rear side (not shown) of the credit card 100, and/or the like. The data storage may store credit card data, such as, the credit card number, the “valid from” and/or “good thru” dates, the credit card holder's name, a verification code and/or the like, in a machine-readable format.

In order to prevent and discourage counterfeiting, stealing and/or fraudulent uses, the credit card 100 may be equipped with a holographic fingerprint image (HFI) 170. The HFI 170 may be a credit card holder's three dimensional (3D) holographic fingerprint image. As known in the art, a holographic image changes its appearance in exactly the same way as if the recorded image were still present as the position and orientation of a viewer or a viewing system change its viewing perspective, thereby making the image appear 3D.

The use of any 3D holographic image by itself may impose a significant financial and technological burden to counterfeiters because it requires significant resources (e.g., costly, specialized and technologically advanced equipment) and techniques to create 3D holographic images. The use of a 3D holographic image of the credit card holder's fingerprint may make it even more difficult to counterfeit the credit card 100 because it may be more difficult or impossible to obtain the credit card holder's fingerprint without the credit card holder's knowledge and consent. Although FIG. 1 shows the 3D HFI 170 located on the front side 110 of the credit card 100, the 3D HFI 170 may be located on the rear side (not shown) of the credit card 100. The 3D HFI 170 may also be stored electronically in, for example, the data storage.

Although FIG. 1 shows the credit card 100, the card user identification verification feature of the disclosure may be applicable to a debit card, a membership card, an access card, an identification (ID) card, a medical insurance card, an automobile insurance card, a driver license card and/or other type of card that may benefit from the card user identification verification feature. Depending on the purpose and usage, the card 100 may be customized. For example, a medical insurance card may include the card holder's personal information, medical information and/or the like in, e.g., the data storage. An access card may include personal information, clearance information and/or the like in, e.g., the data storage. An identification card may include a card holder's picture on the front side in addition to personal information stored in, e.g., the data storage.

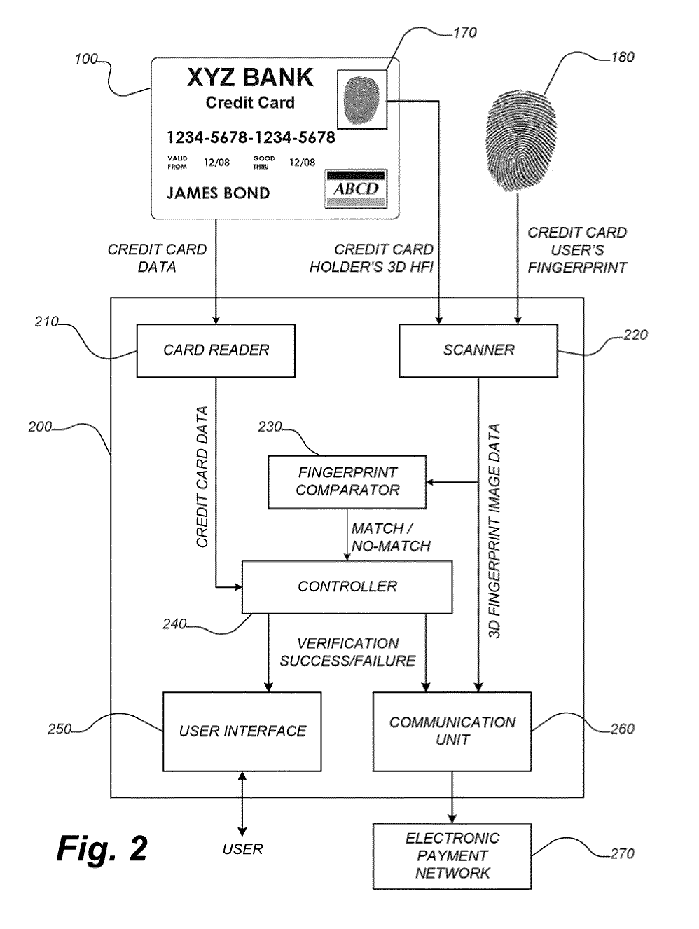

FIG. 2 shows a credit card user identity verification system 200 using holographic fingerprint comparison, constructed according to the principles of the disclosure. The system 200 may require a credit card having a credit card holder's 3D HFI, such as, e.g., the credit card 100 having the 3D HFI 170 shown in FIGS. 1 and 2. The system 200 may include a card reader 210, a scanner 220, a fingerprint comparator 230, a controller 240, a user interface 250, a communication unit 260 and/or the like. As well known in the art, the card reader 210 may be used to read the credit card data stored in the data storage, such as, e.g., a magnetic stripe (not shown), of the credit card 100.

The scanner 220 may be a 3D image scanner. The scanner 220 may be configured with a CCD with a light source, an ND converter and/or the like to produce digital image data. Other types of scanners are contemplated in this disclosure. The scanner 220 may be used to scan the HFI 170 of the credit card 100 and output 3D fingerprint image data of the HFI 170. Furthermore, the scanner 220 may be used to scan a credit card user's fingerprint 180 and output the credit card user's 3D fingerprint image data. For example, during the scanning, the scanner 200 may create numerous cloud points of geometric samples on the HFI 170 and the fingerprint 180. These points may be used to extrapolate the shapes of the HFI 170 and the fingerprint 180. The scanner 220 may output those two sets of 3D fingerprint image data representing the extrapolated 3D shapes of the HFI 170 and the fingerprint 180, respectively, in a machine readable format.

The fingerprint comparator 230 may be used to compare the two sets of 3D fingerprint image data from the scanner 220, and determine whether or not the two sets of 3D fingerprint image data match each other. For example, when the two sets of 3D fingerprint image data match each other, the fingerprint comparator 230 may output a match signal. However, when the two sets of 3D fingerprint image data do not match each other, the fingerprint comparator 230 may output a no-match signal.

The controller 240 may be configured to execute various operations to control and operate the system 200. For example, the controller 240 may perform collecting credit card data from the credit card 100 using the card reader 210, scanning the HFI 170 and the fingerprint 180 using the scanner 220, comparing the two sets of 3D fingerprint image data using the fingerprint comparator 230, taking actions based on the comparison result, interacting with a user (e.g., a cashier) using the user interface 250, communicating with an electronic payment network 270 (e.g., a credit card company) using the communication unit 260 and/or the like.

Particularly, when the controller 240 receives a match signal from the fingerprint comparator 230, the controller 240 may output a verification success message to the user via the user interface 250. However, when the fingerprint comparator 230 outputs a no-match signal, the controller 240 may take necessary steps to prevent the credit card 100 from being used for payment, reservation, identification verification and/or any other purposes. For example, the controller 240 may automatically interrupt any transaction involving the credit card 100. Furthermore, the controller 240 may output a verification failure message to the user via the user interface 250.

Additionally, the controller 240 may send a verification failure message to the electronic payment network 270 via the communication unit 260. The verification failure message may be accompanied by additional information, such as, e.g., the credit card data, a verification failure time and location and/or the like. The additional information may be used for electronic payment network 270 to notify the credit card holder of an occurrence of the fraudulent credit card use. The controller 240 may also send the credit card user's fingerprint image data to the electronic payment network 270. A law enforcement agency may then use the credit card user's fingerprint image data to identify, arrest and prosecute the fraudulent credit card user.

The user interface 250 may be used to output the verification success/failure message to the user. The user interface 250 may be a display device, an audio device, a printer and/or the like. For example, the user interface 250 may be a computer screen that displays a verification success/failure message in a text and/or graphic format. An audio device, such as, e.g., a speaker system, may be also used to generate an alert sound when a verification success/failure occurs.

The communication unit 260 may be used to connect the system 200 to the electronic payment network 270 via a telephone line, a power line, a wired or wireless computer network and/or the like. The communication unit 260 may be a modem, a network interface and/or the like, as well known in the art. Depending on the fingerprint comparison result from the fingerprint comparator 230, the controller 240 may send a different message and/or data to the electronic payment network 270 via the communication unit 260. For example, when the fingerprint comparator 230 outputs a match signal, the controller 240 may send a transaction authorization request, an amount to be charged for a transaction, the credit card data and/or the like to the electronic payment network 270. However, when a no-match signal is received from the fingerprint comparator 230, the controller 240 may send a verification failure message, the credit card data, the credit card user's 3D fingerprint image data and/or the like to the electronic payment network 270.

According to the disclosure, a credit card user's identification may be verified solely based on the 3D fingerprint image comparison and there may be no need to communicate with a remote location for sending or receiving data for identification verification. Thus, the system 200 may independently and instantly perform identification verification on-site. Furthermore, counterfeiting, stealing and/or fraudulent use of the card 100 may be significantly discouraged because the credit card 100 may not be used without scanning a credit card user's fingerprint and the scanned fingerprint image may be used by the law enforcement agency to identify, arrest and prosecute the counterfeiters and/or fraudulent users.

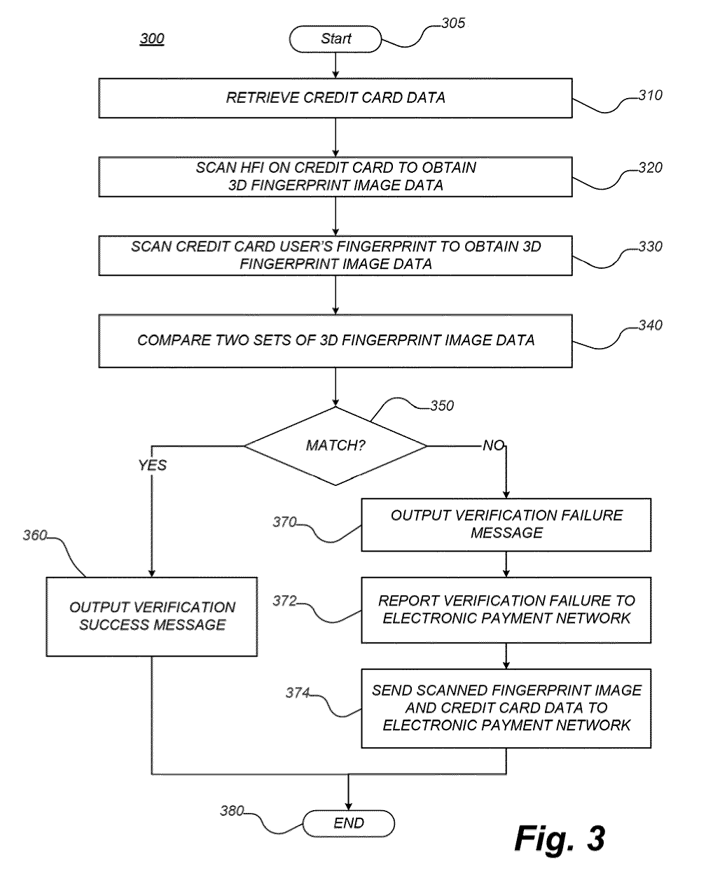

FIG. 3 shows a flowchart 300 of a credit card user identification verification process 300, implemented according to the principles of the invention. The process 300 may be typically performed in a retail situation where a credit card is used for a transaction, reservation, identification verification and/or other activity. The identification verification process 300 may require a credit card with a credit card holder's 3D HFI, such as, e.g., the credit card 100 having the 3D HFI 170 as seen in FIG. 1.

Upon starting the process 300 at 305, a credit card may be read to retrieve credit card data stored in a data storage (e.g., a magnetic stripe) of the credit card at 310. Then, the 3D HFI of the credit card may be scanned at 320 in order to obtain 3D fingerprint image data thereof. The credit card user's fingerprint may be scanned at 330 in order to obtain 3D fingerprint image data thereof. Those two sets of 3D fingerprint image data may be compared at 340, and it may be determined whether or not the two sets of 3D fingerprint image data match each other at 350.

When the two sets of the fingerprint image data match each other at 350, a verification success message may be output at 360, and the process 300 may be terminated at 380. However, when the two sets of the fingerprint image data do not match each other at 350, a verification failure message may be output at 370. Furthermore, the verification failure message may be sent to an electronic payment network at 372. The verification failure report may be accompanied by the credit card data retrieved from 310. Additionally, the credit card user's 3D fingerprint image data may be sent to the electronic payment network and/or a law enforcement agency at 374 to identify, arrest and prosecute the fraudulent credit card user. The process 300 may also include the ability to return to 330 in the event there was an error in scanning the credit card user's fingerprint at 330.

Since identification verification may be performed solely based on the fingerprint image comparison, the process 300 may be instantly and independently performed on-site without needing to send or receive any information to a remote location. Furthermore, the likelihood of a fraudulent credit card use may be significantly diminished because the credit card user's 3D fingerprint image data may be used to identify, arrest and prosecute the fraudulent credit card user.

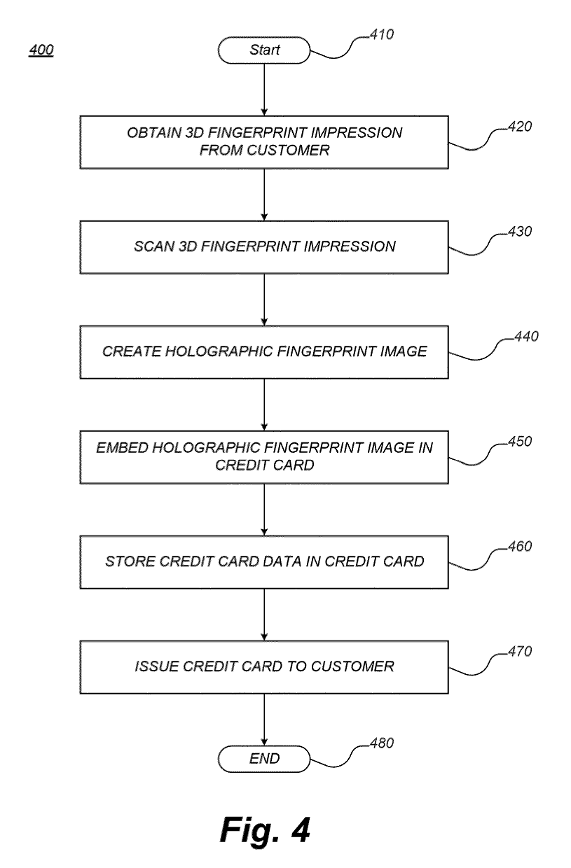

FIG. 4 shows a flowchart 400 of a process for manufacturing a credit card having a credit card holder's 3D holographic fingerprint image (HFI), implemented according to the principles of the invention. Upon starting at 410, a customer's 3D fingerprint impression may be obtained at 420. The 3D fingerprint impression may be obtained when a customer applies for a credit card. For example, a credit card application form may be provided with a fingerprint impression kit. The kit may include an impression pad formed of a soft and dense material, such as, wax, clay or the like. The impression pad may have a flat surface and a certain thickness. The customer may leave a 3D impression of his or her fingerprint on the impression pad by pressing the fingertip to the flat surface thereof. The customer may then mail the impression pad with the completed application form to the credit card company. Alternatively, the customer may visit a fingerprinting facility where his or her 3D fingerprint impression may be taken and provided to the credit card company. Other ways of obtaining the fingerprint impression are contemplated.

The 3D fingerprint impression may be then scanned at 430 and converted to a holographic fingerprint image (HFI) at 440. The customer's HFI may be printed out and embedded in a blank credit card at 450. After storing credit card data, such as, e.g., a credit card number, a credit card holder's name, an expiration date and/or the like, in a data storage (e.g., magnetic stripe) of the credit card at 460, the credit card may be issued to the customer at 470 and the process may terminate at 480. The credit card manufactured according to the process 400 may be used for the credit card user identification verification process 300 shown in FIG. 3.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A system for verifying a credit card user's identification comprising:
a scanner configured to scan a holographic fingerprint image on a credit card and a credit card user's fingerprint and output first fingerprint image data representing the holographic fingerprint image and second fingerprint image data representing the credit card user's fingerprint;
a comparator configured to compare the first fingerprint image data and the second fingerprint image data and determine whether the first fingerprint image data matches the second fingerprint image data; and
a control unit configured to issue a verification message based on the first fingerprint image data and the second fingerprint image data.

2. The system of claim 1, wherein the control unit is further configured to issue a verification success message when the first fingerprint image data matches the second fingerprint image data.

3. The system of claim 2, further comprising an output device configured to output one of the verification failure message when the first fingerprint image data does not match the second fingerprint image data.

4. The system of claim 3, wherein the output device comprises at least one of a display unit, a speaker system and a printer.

5. The system of claim 3, further comprising a communication unit configured to establish communication between the system and an electronic payment network.

6. The system of claim 5, wherein the control unit is further configured to transmit the verification failure message to the electronic payment network when the first fingerprint image data does not match the second fingerprint image data.

7. The system of claim 6, wherein the control unit is further configured to transmit at least one of credit card data and the second fingerprint image data to the electronic payment network when the first fingerprint image data does not match the second fingerprint image data.

8. The system of claim 7, wherein the credit card data comprises at least one of a credit card number, a credit card expiration date, a verification code and a credit card holder's name.

9. The system of claim 7, further comprising a card reader configured to retrieve the credit card data from the credit card.

10. A method of verifying a credit card user's identification, comprising:
scanning a holographic fingerprint image on a credit card to obtain first fingerprint image data;
scanning a fingerprint of a user of the credit card to obtain second fingerprint image data;
comparing the first fingerprint image data and the second fingerprint image data to determine whether or not the first fingerprint image data matches the second fingerprint image data; and
outputting a verification message based on the first fingerprint image data and the second fingerprint image data.

11. The method of claim 10, further comprising outputting a verification success message when the first fingerprint image data matches the second fingerprint image data.

12. The method of claim 10, wherein the outputting a verification failure message comprises at least one of:
displaying the verification failure message;
playing a sound; and
printing out verification failure message.

13. The method of claim 12, further comprising sending the verification failure message to an electronic payment network when the first fingerprint image data does not the second fingerprint image data.

14. The method of claim 13, further comprising sending at least one of credit card data and the second fingerprint image data to the electronic payment network when the first fingerprint image data does not match the second fingerprint image data.

15. The method of claim 14, wherein the credit card data comprises at least one of a credit card number, a credit card expiration date, a verification code and a credit card holder's name.

16. The method of claim 14, further comprising retrieving the credit card data from the credit card.

17. A method of making a credit card, comprising:
obtaining a three dimensional impression of a customer's fingerprint;
scanning the three dimensional impression to obtain a three dimensional fingerprint image data;
creating a holographic fingerprint image from the three dimensional fingerprint image data;
printing the holographic fingerprint image; and
embedding the printed holographic fingerprint image to a credit card.

18. The method of claim 17, wherein the obtaining the three dimensional fingerprint impression comprises pressing the customer's fingertip to an impression pad to leave the three dimensional fingerprint impression thereon.

19. The method of claim 17, further comprises storing credit card data to the credit card, wherein the credit card data comprises at least one of a credit card number, a credit card expiration date, a verification code and a customer's name.

20. A credit card made by the process of claim 17.
